(19) United States
(12) Patent Application Publication
(10) Pub. No.: US 2022/0339925 A1
(43) Pub. Date: Oct. 27, 2022

(54) FOAMED FILLER ROD IN OPTICAL FIBER CABLES

(71) Applicant: Arkema Inc., King of Prussia, PA (US)

(72) Inventors: Skip M. Sparks, King of Prussia, PA (US); James J. Henry, King of Prussia, PA (US); Luigi Puglia, King of Prussia, PA (US); David A. Kreh, King of Prussia, PA (US)

(21) Appl. No.: 17/765,460

(22) PCT Filed: Nov. 5, 2020
(86) PCT No.: PCT/US2020/058998

§ 371 Date: Mar. 31, 2022

Related U.S. Application Data
(60) Provisional application No. 62/937,297, filed on Nov. 19, 2019.

(51) Int. Cl. B32B 37/15; G02B 6/44; B32B 7/022; B32B 27/06; B32B 27/08; B32B 27/20; B32B 27/30; B32B 5/20

(52) U.S. Cl. CPC B32B 37/153; G02B 6/4436; B32B 7/022; B32B 27/065; B32B 27/08; B32B 27/20; B32B 27/304; B32B 5/20; B32B 2266/0235; B32B 2250/02; B32B 2250/24; B32B 2307/3065; B32B 2305/022; B32B 2457/00

(57) ABSTRACT

The present invention relates to optical fiber communication cables, and more particularly, relates to foamed polyvinylidene fluoride polymer filler rods used in optical fiber cable constructions. The foamed polyvinylidene fluoride polymer filler rod may or may not contain a central strength member. This invention includes cables containing the foamed PVDF filler rods of this invention. The present disclosure provides filler rods that have higher melting temperature than the conventional filler rods and methods of making the filler rods.

### FIELD OF THE INVENTION

The present invention relates to optical fiber cable components commonly referred to as filler rods and strength members where one or more of the components is comprised of foamed PVDF polymer. The present invention also relates to optical fiber cables used in applications requiring low flame spread and smoke generation such as those described as plenum or riser rated cables.

### BACKGROUND OF THE INVENTION

An optical fiber cable in its simplest form consists of one or more optical fibers, one or more strength members, and a protective polymer jacket. The optical fiber, which used to transport optical signals and normally produced from high purity glass, but can also be a polymer. A thin outer coating of a material having a different refractive index is applied over the optical fiber. This outer coating is normally referred to as the cladding. The cladding creates an interfacial boundary layer able to contain light waves thus enabling them to travel long distances within the fiber length. A protective polymeric jacket is sometimes applied over the optical fiber to prevent damage from excessive cable bends. This protective polymeric jacket is referred to as a buffer layer. Strength members such as multifilament fibers, wire strands or rigid composite rods are introduced to protect the optical fibers from crushing forces and excessive tension during installation. One commonly used strength member consists of high strength aromatic fibers (such as Kevlar® fibers). Strength members can reside in the same spaces containing the optical fibers or within other free space located within the cable. A cable jacket is than applied over the optical fibers and strength members to produce the final cable. The cable jacket retains the optical fibers and protects them during shipment, handling, installation and use.

In more complex optical fiber cables, multiple core tubes, often called “buffer tubes”, are introduced. Each core tube within the cable can be used to contain one or more optical fibers. Several core tubes can be bundled together and wrapped with a supporting tape. An outer polymer jacket can be applied over a bundle of core tubes to produce an optical fiber cable. Fiber optic cables having multiple core tubes can contain high numbers of optical fibers. Fiber optic cables containing 144 individual optical fibers would be a good example of a high number of optical fibers. For Optical Fiber cables containing multiple core tubes, a solid central strength member is often included to strengthen the optical fiber cable and reduce stresses on the optical fibers. The central strength member limits cable bending and handles tensile stresses that can damage optical fibers. The central strength member consists of a polymer composite rod (often epoxy/glass) or metal wire, and is often jacketed with a polymeric material. The primary purpose of this outer jacket is to achieve a desired outside diameter needed to fill open space within the cable. In most cases, the outside diameter (OD) of the strength member is the same as the OD of the core tubes.

In general, optical fiber cables are configured to form the cable into a concentric and symmetrical pattern. One common configuration consists of a central core tube, a group of core tubes or a central strength member surrounded by several core tubes. Each of the core tubes contained in this construction can be used to contain optical fibers. Each core tube can also retain components to protect the optical fibers including multifilament strength members or water blocking agents. The cable core is then tape wrapped to hold the core tubes together, and then jacketed by profile extrusion with a protective outer polymeric jacket. Other components that are often included in the cable include additional reinforcing yarns, water-blocking materials and ripcords. In general, the size, number and layout of individual core tubes contained around the central core is adjusted to minimize the cables cross sectional while supporting a high fiber count.

One common configuration in fiber optic cables is to arrange six individual core tubes around a central strength member (having a similar OD as the core tubes) to produce a finished cable having a round cross section. A round cross section is beneficial during spooling, unspooling and cable installation. It is common practice to design a fiber optic cable to have a round cross section.

There are situations where the end-user desires the benefits of high pair count loose tube optical fiber cable structure, but requires less optical fibers than its maximum capacity. For example, if the cable contains six core tubes but only 4 tubes with optical fibers are needed, than the addition of unused optical fibers simply adds costs with no value. The remaining other two core tubes (to keep the cable symmetric/round) can remain empty (no optical fibers), but could still contain strength members or filler rods which are typically the size of a core tube and preferably within 10% of the diameter of the core tube construction.

As an alternative to using empty core tubes to fill spaces is to use a filler rod. A filler rod serves the same purpose, and is introduced for the same reasons as an empty core tube. Like an empty core tube, the filler rod is normally produced having an OD similar to the core tube being replaced. The filler rod cannot introduce any negative attributes to the cable. In general, the performance requirements for most filler rods include low post shrinkage, crush resistance, and dimensional stability.

For optical fiber cables installed in buildings, it is common to have fire performance requirements defined for flame spread and smoke generation in the event of a fire. A good example would be NFPA 90A “Standard for the Installation of Air-Conditioning and Ventilation Systems” which defines fire performance requirements for materials used in building plenum spaces. NFPA 90A requires all cables installed in plenum spaces be able to pass the flame and smoke requirements defined in NFPA 262 “Standard Method of Test for Flame Travel and Smoke of Wires and Cables”. Cables able to meet these requirements are referred to as Plenum cables or CMP cables. For another example, cables installed in vertical building spaces such as interior and exterior walls need to meet the flame and smoke requirements of UL 1666 “Standard for Test for Flame Propagation Height of Electrical and Optical-Fiber Cables installed in vertically in Shafts”. Cables capable of meeting these requirements are referred to as Riser Cable or CMR cables. For both Plenum and Riser cables, limits are placed on flame spread and smoke generation.

Fire tests used to rate flame and smoke properties of materials independent of whether they are bench top or full scale tests, all use a defined heat load, heat application rate and exposure time. During the test, important responses are monitored such as flame travel (spread), smoke generation and heat release rate.

In order to meet plenum requirements, polymer materials having significantly higher flame and smoke performance are needed. PVC compounds referred to as Low-Smoke PVC (LSPVC) are commonly used as insulation materials for plenum cables and offer higher fire performance compared to Low Smoke Zero Halogen (LSZH) compounds. The LSPVC polymers were developed to pass NFPA 262 while still achieving other needed performance requirements. LSPVC polymers are heavily compounded with fillers, flame retardants, plasticizers and stabilizers and used for both copper and fiber optic cables. LSPVC polymers are used to produce a variety of cable structures including but not limited to primary insulation, jackets, spacers, buffer tubes, strength members and filler rods. LSPVC polymers will contribute to flame spread and smoke generation, which limits the amount that can be included in a cable and still able to meet Plenum requirements. LSPVC polymers are limited to lower temperature applications normally below 120° C. or lower.

For larger cables containing higher amounts of combustible materials, the replacement of some or all of the LSPVC with fluoropolymers is sometimes needed

Besides material selection, cable design can also affect cable performance in a simulated fire test. As an example, the presence of open core tubes in a fiber optic cable construction can adversely affect flame and smoke performance. During a fire test, or in the event of a fire, an open core tube can funnel hot gasses inside and down the length of a cable. When this occurs, the cable begins to melt prematurely from the inside resulting in premature cable burning and higher levels of smoke generation.

Often times, a core tube is not needed, and to fill this space, a filler rod is introduced in its place. The introduction of a filler rod is not hollow and inherently prevents the free flow of hot gasses during a flame test thereby improving flame and smoke performance. Of course, the selection of material used to produce the filler rod is important. The addition of LSPVC filler rods will add to the fuel load and to smoke generation during a fire test. The use of LSPVC filler rods at times cannot be included in larger plenum cables containing higher quantities of combustible materials. Such cables often just barely meet plenum requirements, and the addition of LSPVC filler rods would lead to test failure.

As mentioned earlier, an ideal filler rod would be one that has an overall stiffness similar to the core tube being replaced. In most cases, the filler rod should be relatively soft and flexible. An improved plenum rated filler rod would provide improved flame and smoke performance properties. This invention addresses this issue by producing the filler rod using a foamed PVDF polymer. A filler rod comprised of foamed PVDF resin would result in improved flame and smoke performance as well as other potential benefits including higher melting point, low temperature flexibility, and also providing improved chemical and oxidation resistance. A higher melting point would be useful in environments with temperatures above ambient. A foamed PVDF filler rod is more flexible than a solid filler rod, and this flexibility can be tuned by adjusting the foam density to achieve a target stiffness. A foamed PVDF filler rod also has a reduced caloric content, which improves fire test performance. In addition, foamed PVDF filler rod reduces cable weight, which is a benefit during shipment and installation, and of course, reduces the material costs. Filler rods produced with foamed PVDF having high density reductions (greater than 30% density reduction) are expected to be preferred for several reasons including better overall flame and smoke properties.

It is a known practice to use solid or foamed dummy members in an optical fiber cable construction. U.S. Pat. No. 4,550,976 entitled “Optical fiber Cable with Foamed Plastic Dummy Members” describes an optical fiber cable comprised of a core member (later noted as being as strength member), at least one tubular member (noted as containing at least one optical fiber) and at least one “dummy” member having a diameter less than the diameter of the tubular member with a jacket composed of a foamed plastic material. The invention mentions the use of fluoropolymers for making tubes but discounts the use of fluoropolymers as being too expensive and not providing any benefits to the cable construction.

A filler rod described in U.S. Pat. No. 6,066,397 “Polypropylene Filler Rod for Optical Fiber Communication Cables” is a filler rod produced with PP and found useful in conventional optical fiber cables. The product described by this invention is solid and is very flammable, and not useful in plenum or other cables needing flame and smoke performance.

The filler rod composition of 2014/0064683 describes a blend of polyethylene and polypropylene that is thermodynamically unstable. This composition would not be useful in plenum or other cables needing flame and smoke performance due to the high flammability of these two components.

The filler rod composition of 2012/0063730 entitled “Flame Retardant Cable Fillers and Cables” describes a polyolefin composition containing a hindered amine that acts as a flame retardant. This is consistent with an HFFR type composition and would be unsuitable for plenum cables or other building cables needing higher levels of flame and smoke performance.

There is a need for a lightweight filler rod with “tunable” flexibility for plenum fiber cables that does not exist today. The term “tunable” is used herein to describe the ability to change an important physical property without having to change the polymers composition. In this particular case, the addition of a foaming agent results in a reduction in density and improves the polymers flexibility. As a general rule, the more foam concentrate that is used, the lower the final density, and higher the polymers flexibility. Other common means of improving flexibility such as increasing comonomer content or adding a flexibilizing agent require a change in polymer composition.

One way to characterize flexibility is by measuring the flexural modulus of the polymer per ASTM D790. Generally, the lower the flexural modulus, the higher the flexibility. To improve flexibility, one could introduce foaming to lower the flexural modulus. When foaming is introduced to achieve an overall density reduction of 50 percent, the flexural modulus is also reduced by about 45 to 55%.

The best option today is a low smoke PVC (LSPVC) solid filler rod. The addition of LSPVC filler rods can increase smoke generation and reduce overall flame and smoke performance when tested per NFPA 262. It has been found surprisingly that foam PVDF filler rods of this invention allow cables to pass this difficult flame and smoke standard. Flexibility can be adjusted as needed by PVDF polymer selection and by adjusting density reduction.

### SUMMARY OF THE INVENTION

The present disclosure provides filler rods having higher upper use temperature (above 120° C. to a maximum use temperature of 150° C.), better flame resistance properties and lower densities, and tunable flexibilities compared to conventional filler rods and includes methods of making the filler rods. The filler rod is comprised of, consists essential of, or consists of a PVDF polymer or copolymer that has been foamed to reduce the density and can contain a strength member such as an aramid fiber tow.

The composition of the foamed rod comprised of, consists essential of, or consists of PVDF homo or copolymer, expandable microspheres, optionally additive such as fillers, flame-retardants, antioxidants, impact modifier, colorants or color concentrates, which preferably surrounds a strength member.

### BRIEF DESCRIPTION OF THE DRAWINGS

FIG. 1: cross section of a prior art of a loose tube optical fiber cable employing an unfoamed LSPVC filler rod (1) having a central multifilament strength member.

FIG. 2: Cross section of one embodiment of a loose tube optical fiber cable employing two filler rods comprised of foamed PVDF polymer (7).

FIG. 3: Cross section of another embodiment of a loose tube optical fiber cable employing two filler rods comprised of foamed PVDF polymer (7) and containing a central multifilament strength member (2).

### DETAILED DESCRIPTION OF THE INVENTION

The references cited in this application are incorporated herein by reference.

Percentages, as used herein are weight percentages, unless noted otherwise, and molecular weights are weight average molecular weights, unless otherwise stated.

“Copolymer” is used to mean a polymer having two or more different monomer units. “Polymer” is used to mean both homopolymer and copolymers. For example, as used herein, “PVDF” and “polyvinylidene fluoride” is used to connote both the homopolymer and copolymers, unless specifically noted otherwise. Polymers may be straight chain, branched, star, comb, block, cross-linked or any other structure. The polymers may be homogeneous, heterogeneous, and may have a gradient distribution of co-monomer units. As used herein, unless otherwise described, percent shall mean weight percent. Molecular weight is a weight average molecular weight as measured by gas permeation chromatography (GPC). In cases where the polymer contains some cross-linking, and GPC cannot be applied due to an insoluble polymer fraction, soluble fraction / gel fraction or soluble fraction molecular weight after extraction from gel is used.

Halogen Free Flame Retarded or “HFFR”, and also referred to as Low Smoke Zero Halogen (LSZH) refers to polymer formulations based on blends of polyethylene and ethylene copolymers combined with high levels of mineral fillers such as aluminum trihydrate (ATH) to optimize flame retardant properties and reduce costs.

Co extrusion describes a melt process where two or more polymers are applied at the same time.

Tandem extrusion is the process of producing a product having two of more layers where each layer is applied in a separate step. The tandem extrusion can be performed on a single production line in sequence or extruded on one line, then collected on a reel and then uncoiled later and a second extrusion layer applied.

A fiber optic cable is a cable that contains at least one optical fiber.

Many aspects of the disclosure are better understood with reference to the following drawings. The components in the drawings are not necessarily to scale with emphasis instead being placed upon clearly illustrating the principles of the present disclosure. Moreover, in the drawings, like reference numerals designate corresponding parts throughout the several views.

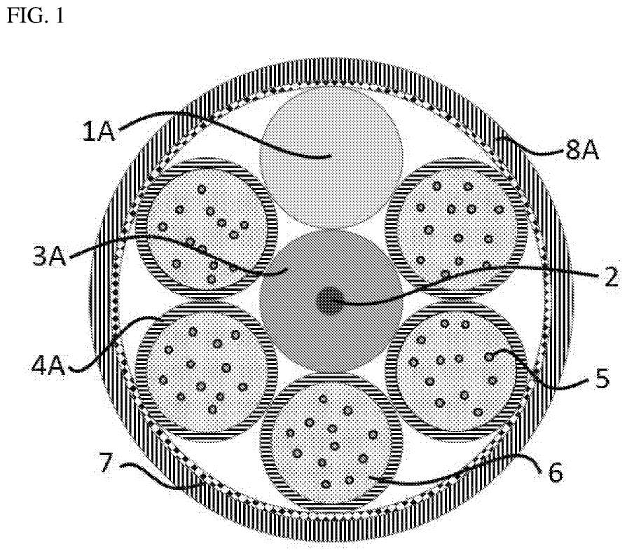

FIG. 1 is a cross section of a prior art of a loose tube optical fiber cable employing a dummy filler rod and a central strength member. The filler rod (1A) is produced using an unfoamed low smoke PVC or HFFR polymer and is an example representing prior art. The optical fiber cable consists of five core tubes (4A) with each core tube containing twelve optical fibers (5) and containing multifilament strength members (6). A solid strength member (2) resides in the center of the cable. The solid strength member (2) is coated with a PVC or HFFR jacket (3A) to an OD similar to the OD of the core tubes (4A). The cable in this example is designed with six core tubes containing 72 optical fibers. For this prior art example, one of the core tubes was replaced with a polymeric filler rod (1A) which does not contain any strength member. The composition of filler rod (1A) could any polymer, but often is the same polymer used to jacket the central strength member jacket (3A), the core tube (4A) or the cable jacket (8A). The core tubes are wrapped with a polyester tape (7), and jacketed with a suitable polymer (8A). The composition of the cable jacket (8A) could be any polymer, but often is same polymer used for the core tubes (4A) or the filler rod (1A).

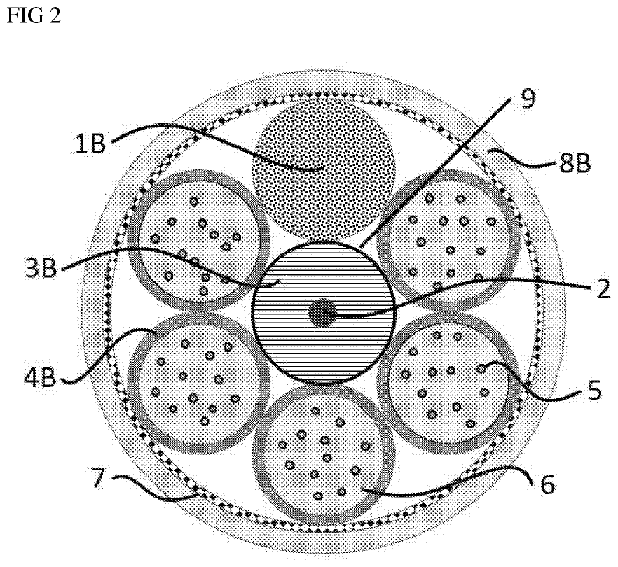

FIG. 2 is a cross section of a plenum rated loose tube optical fiber cable employing two filler rods and is an embodiment of this invention. For this example, all polymers are halogenated and chosen to provide suitable flame resistant properties. The cable consists of five plenum rated core tubes (4B) with each core tube containing twelve optical fibers (5) and containing multifilament strength members (6). A solid strength member (2) resides in the center of the cable and jacketed with a foamed PVDF polymer (3B) to an outside diameter similar to the core tubes (4B). The foamed jacket over the strength member contains an additional unfoamed PVDF outer layer (9) applied by co-extrusion. The purpose of the outer layer is to provide a smooth outer surface. The cable is designed with six plenum rated core tubes (4B) containing 72 optical fibers (5). For this example, one of the core tubes was replaced with a PVDF foamed filler rod (1B) that is without a strength member. The composition of filler rod (1B) is a foamed PVDF polymer. The composition of the filler rod is often the same as used to jacket the central strength member (3B). The core tubes are wrapped with a polyester tape (7), and jacketed with a suitable polymer (8B). The composition of the cable jacket (8B) could be any plenum rated polymer.

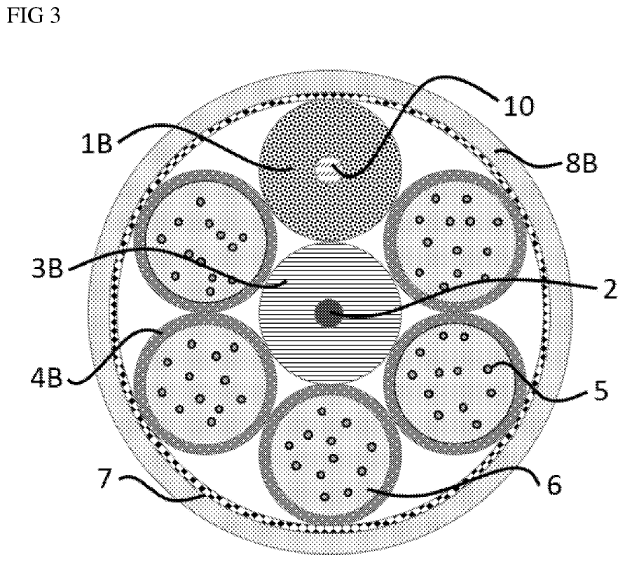

FIG. 3 is a cross section of another plenum rated loose tube optical fiber cable employing two filler rods and is an embodiment of this invention. For this example, all polymer polymers used are halogenated and chosen to provide suitable flame resistance properties. The cable consists of five plenum rated core tubes (4B) with each core tube containing twelve optical fibers (5) and containing multifilament strength members (6). A solid strength member (2) resides in the center of the cable and is jacketed with a foamed PVDF polymer (3B) to an outside diameter similar to the core tubes (4B). The cable is designed with six plenum rated core tubes (4B) containing 72 optical fibers (5). For this example, one of the core tubes was replaced with a PVDF foamed filler rod (1B) that contains a centrally located strength member (10). The composition of filler rod (1B) is a foamed PVDF polymer. The composition of the filler rod is often the same as used to jacket the central strength member (3B). The core tubes are wrapped with a polyester tape (7), and jacketed with a suitable polymer (8B). The composition of the cable jacket (8B) could be any plenum rated polymer. The object of the invention is a filler rod having improved fire rating as compared to the presently used LSPVC. Applicants have found that foamed PVDF filler rod to be used primarily in Optical fiber (FO) cables provided an improved product over those presently available. Fluoropolymers provide better properties than LSPVC including low flame and smoke, elevated temperature, chemical resistance, physical and mechanical properties, environmental resistance and expected useful life. By reducing the density of PVDF (40-80%), a lightweight flexible filler rod can be produced while still maintaining excellent properties.

In one embodiment of the invention is a polyaramid reinforced filler rod for cable constructions. It provides structural support and fills in a spot in the cable that would otherwise be empty.

The material currently being used for this application is Low Smoke PVC. Foamed PVDF has increased chemical resistance, reduced density and improved flame and smoke properties. By low smoke is meant the material meets the NFPA 262 requirements.

This product can replace low smoke PVC filler rods currently used in cables. The foamed PVDF rod offers improved flame and smoke characteristics as well as chemical resistance. The reduction in density (because of foaming) would reduce weight and quantity of material used.

The general construction of a filler rod can be produced with or without a strength member and can be produced with or without an outer skin layer (a layer without foam) to improve surface smoothness. The filler rod when produced as a foam can introduce any desired density reduction achievable. Any PVDF grade capable of being melt processed including blends and regrind can be used to produce a filler rod. Any foaming technology able to produce a PVDF foam can be used.

Having provided an overview of the filler rods, reference is now made in detail to the description of the embodiments as illustrated in the drawings. While several embodiments are described in connection with the drawings, there is no intent to limit the disclosure to the embodiment or embodiments disclosed herein.

The filler rods help to maintain the overall substantially round concentric structure.

According to the present invention, filler rods comprised of a foamed polyvinylidene fluoride (PVDF) polymer have a higher upper use temperature than conventional filler rods. Filler rods providing higher upper use temperature is important in applications where heat generation may occur such as in hybrid fiber optic cables that also contain power cables. Filler rods produced with polymers rated for higher temperatures can be used in such higher temperature environments.

### Filler Rods

The disclosed filler rod is a rod comprised of, consists essential of, or consists of a foamed polyvinylidene fluoride (PVDF) homo or co-polymer and preferably a strength member. The strength member is preferably located centrally inside the foamed filler rod. It is preferred the strength member is made from polyaramide fibers (Kevlar®). In general, the filler rod is in a round shape but depending of the application can be made into other shapes, for example oval, star or others.

The dimensions of the filler rod are dependent on the application. The length and diameter or width can be adjusted to fit the application. Dimensional changes include but are not limited to differences in width, length, thickness, overall shape (round, oval, star, regular polygons, etc.). The filler rod can have a continuous cross section or can have a hollow center. The hollow center may optionally contain other non-fiber-optic materials.

The disclosed filler rod contains foamed PVDF. The material is formed into a rod by passing through a die, then immediately quenched cooled in using a water bath.

The foamed filler rods can be produced with a wide range of polvinylidene fluoride (PVDF) polymers having different levels of stiffness. The addition of foaming reduces the stiffness of the rod compared to a rod that is not foamed. The ease of adding foam to reduce the density is such that rods of various stiffness can be produced simply by adjusting the level of foaming agent. The ability to adjust properties such as stiffness is referred to as being tunable. The ability of these filler rods being tunable can be useful in that the stiffness of the filler rod can be tuned to be similar to the tube that it is replacing in the cable. This will help to ensure the overall feel and performance of the cable is not compromised by the addition of the filler rod.

The rods without strength members are not structural; they are spacers, which do not contribute to the mechanical characteristics of the finished cable. With the addition of an internal strength member, the filler rods can also provide a structural contribution by helping to manage tensile stresses encountered during installation.

The foamed filler rods are used in fire resistant cables such as those used in plenum spaces. Currently LSPVC rods contribute a significant level of smoke during a fire. The use of the foamed PVDF rods will reduce flame and smoke performance for the entire cable as there will be little to no contribution of flame and smoke from the PVDF during a fire. Replacement of the LSPVC filler rod with a foamed PVDF filler rod will provide an enhancement since the foamed PVDF polymer will not contribute smoke in the presence of a fire. Furthermore, due to better char forming capabilities of PVDF polymers, the addition of a foamed PVDF filler rod will improve overall flame and smoke performance.

The foamed filler rods provide higher resistance to cracking at low temperatures. The presence of the bubbles acts as a cushion to provide better overall resistance to cracking at low temperatures. PVDF grade selection is important when crack resistance at low temperatures is required. PVDF copolymers identified as heterogeneous are often selected for improved low and high temperature performance.

An extremely useful property of foamed PVDF filler rods is that it does not stick to LSPVC or PVDF when applied as a jacket during jacket extrusion. The PVDF polymer used to produce a PVDF filler rod is a semi-crystalline polymer, and has a melting point between 122 and 170° C., and with grade selection, are expected to provide melting points between 145 and 168° C. When a PVDF polymer comes in contact with a molten polymer, since it requires a lot of energy to melt a PVDF polymer, it normally does not melt. PVDF polymers need to melt in order to stick to another polymer. LSPVC, conversely, are amorphous polymers and do not have a specific melting temperature. When LSPVC comes in contact with a molten polymer, it can soften and stick to the molten polymer. A typical melt temperature when extruding LSPVC is from 190 to 200° C., and a PVDF jacket would be from 210 to 240° C. When either a LSPVC or PVDF jacket is applied to a cable core containing filler rods, it will often come in direct contact with the filler rods. Since PVDF polymers are crystalline, and require a significant amount of heat to melt and stick to the jacket, a foamed PVDF filler rod is much less likely to stick to the jacket. Unfortunately, filler rods produced with LSPVC are more prone to sticking and often require process adjustments or other steps to reduce its occurrence. Barrier tapes can be applied over a core containing filler rods such as LSPVC as a means of preventing sticking of the jacket to the filler rods. Cables using foamed PVDF filler rods do not need to contain barrier tapes to prevent sticking to the jacket as the PVDF filler rods will not soften to the point where they stick under the processing conditions. Barrier tape adds cost and reduces manufacturing efficiency by adding additional complexity to the cable construction.

The foamed PVDF and the amount of density reduction in the disclosed filler rods can be adjusted depending on factors such as the type of cable, material for the cable jacket, manufacturing line speed, and interest in enhancing other property of the filler rods. In some embodiments, the filler rod contains at least 20% by weight PVDF. Preferably, the filler rod contains at least 50% by weight PVDF based on total weight of filler rod.

The filler rods are foamed by chemical or physical foaming agents. The foamed filler rods can reduce the cost of the filler rods by reducing the mass of material used for the filler rods making them more environmental friendly than solid rods.

It is desirable that filler rods for optical fiber cables undergo a minimum amount of shrinkage during lifetime of the cable because the lower shrinkage of the filler rods will reduce stress on the optical fibers contained in the core tubes in the cable when exposed to high temperatures including aerial installation. In addition, excessive post extrusion shrinkage of filler rods within a cable reduces crush resistance of the cable, especially in low fiber count cables with many filler rods. In some embodiments, post extrusion shrinkage of the filler rod is less than 5%, preferably less than 3% when measured using the shrinkback test described in UL2556.

Furthermore, because the filler rods fill the space that would normally be occupied by a core tube, the diameter of the filler rod is approximately (with 10% of the core tube diameter, preferably within 5%) the same as a cross sectional area of one or more core tubes for the optical fiber cable.

Although exemplary embodiments have been shown and described, it will be clear to those of ordinary skill in the art that a number of changes, modifications, or alterations to the disclosure as described may be made. For example, it should be appreciated that the original optical fiber cable configuration may contain less than six loose tubes or more than six loose tubes, and the filler rods may replace any of the loose tubes at any location within the cable. In some embodiments, the optical fibers within a tube maybe fewer than 12 fibers or more than 12 fibers.

In other embodiments, the filler rod is foamed during the extrusion through chemical or physical foaming. The foamed filler rods can further reduce the cost of the filler rods by reducing the mass of material used for the filler rods.

### PVDF Polymers

The term fluoromonomer denotes any monomer containing a vinyl group capable of opening in order to be polymerized and that contains, directly attached to this vinyl group, at least one fluorine atom, at least one fluoroalkyl group or at least one fluoroalkoxy group.

Preferred vinylidene fluoride (VDF) polymers, include homopolymers, and copolymers having greater than 50 weight percent of vinylidene fluoride units by weight, preferably more than 65 weight percent, more preferably greater than 75 weight percent and most preferably greater than 85 weight percent of one or more vinylidene fluoride.

Most preferred copolymers of the invention are those in which vinylidene fluoride units (VF2) comprise greater than 50 percent of the total weight of all the monomer units in the polymer, and more preferably, comprise greater than 70 percent of the total weight of the units. The PDVD polymer can contain other fluoromonomers. Copolymers, terpolymers and higher polymers of vinylidene fluoride may be made by reacting vinylidene fluoride with one or more comonomers. Example comonomers include but are not limited to vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene Other monomers units in these polymers include any monomer that contains a polymerizable C═C double bond.

Fluoropolymers such as polyvinylidene-based polymers are made by any process known in the art. Processes such as emulsion and suspension polymerization are preferred and are described in U.S. Pat. No. 6,187,885, and EP0120524.

It is possible to produce a foamed filler rod using any melt proces sable grade of PVDF polymer available. A melt processable resin is a thermoplastic resin capable of being melt processed on conventional melt processing equipment. PVDF polymers found useful for producing filler rods include both homopolymers of VF2 as well as copolymers. PVDF copolymers could be any available, preferred comonomers are hexafluoropropene (HFP) or chloroteterafluoroethylene (CTFE), and tetrafluoroethylene (TFE). PVDF copolymers found useful include those described as homogeneous, heterogeneous and multimodal. The amount of comonomer can vary depending on application with low comonomer containing grades at levels of 5 percent by weight or less would be useful when stiffness is considered important. The preferred embodiment would be copolymers having between 4 and 20 wt % of comonomer. PVDF homopolymers may be preferred when stiffness and melt temperatures need to be maximized. In most applications, however, copolymers such as hexafluoropropylene may be used where the wt % of comonomer is at levels of up to 20 wt % with higher comonomer content preferable when highly flexible filler rods are desired. These copolymers could be either homogeneous or heterogeneous with heterogeneous grades preferred when low and high temperature properties are considered important. Blends of different PVDF polymers can also be used to obtain intermediate properties.

The rods comprise of any PVDF grade that can be melt processed which can be described herein as a polymer having a melt viscosity below 35, preferably below 32 kpoise when measured by capillary rheometry at 230° C. and a shear rate of 100 s−1. It is understood that grades with higher viscosities are relatively easy to melt process and tend to produce a better foam structure compared to similar grades of lower viscosity. The polyvinylidene polymer used in the invention has a melt viscosity of from 4 to 35 kpoise, preferably between from 6 to 30 kpoise, measured at 230° C. at a shear rate of 100 s⁻¹. In some embodiments, it is preferred that the PVDF has a higher melt viscosity of from 15 to 30 kpoise. PVDF polymers with viscosities at or below 4 kpoise are very fluid and not suitable for producing foamed structures.

### Additives

The rod may contain additives such as fillers, flame-retardants, antioxidants, impact modifier, colorants or color concentrates. The composition of the rod may be as high as 50% by weight additives based on the weight or the fluoropolymer (PVDF) plus additives, preferably less than 25% by weight additives. For PVDF grades used in plenum applications, a flame retardant may be added at levels normally below 5% by weight to improve flame and smoke performance. Flame retardant grades of PVDF polymers are often characterized as having higher Limiting Oxygen Index (LOI) values. A limiting oxygen index value describes the amount of oxygen needed for a material to sustain a flame. As an example, neat PVDF polymers normally have LOI values of at least 40%. When flame retardants are added the LOI can be raised, preferably the LOI would be greater than 50 up to 100, preferably above 60 and more preferably above 70% as defined by ASTM D-2863.

Examples fillers include but are not limited to talc, carbonates, silicates, and alumnosilicates. Flame retardants are known in the art. Example flame retardants include Calcium tungstate as described in U.S. Pat. No. 5,919,852, calcium molybdates and zinc molybdates among many others.

### Foaming

Any technology used to foam the PVDF can be used to create the foam used in the present invention. The PVDF is foamed to a desired density reduction. Preferably, the density reduction of the PVDF due to foaming is from 5% to 70% reduction, preferably 15 to 60% reduction, most preferably 20 to 50% reduction as compared to solid PVDF. The amount of foaming agent is therefore dependent of the desired density for the end product. The foamed PVDF can be generated using chemical or physical blowing agents. In the case of the chemical blowing agent, the gas is created by decomposition of a chemical material by heating it above its degradation temperature. In the case of the physical blowing agent, gas is introduced directly into the polymer matrix that is near or above its melting point. Either type of foaming agents can be used in both continuous or batch foaming processes although batch process mainly use physical blowing agents. Chemical blowing agents are mainly used for higher density foams—down to 50% density reduction, while physical blowing agents can produce light foams—upwards of 10×density reduction.

As a result of the foaming, the flexural modulus of the polymer per ASTM D790 is changed. Generally, the lower the flexural modulus, the higher the flexibility. To improve flexibility, one could introduce foaming to lower the flexural modulus. When foaming is introduced, the flexural modulus of the polymer is reduced by the percent reduction in density +/−7%, preferably +/−5%. For example, a reduction of 60% of density will result in a reduction of the modulus of between 67 and 53%.

A preferred means of foaming the PVDF polymer is the use of expandable microspheres. U.S. Pat. No. 7,879,441 describes a foam article prepared by adding expandable microspheres to an acrylate-insoluble polymer matrix in an extruder. The mixture either may be expanded in the extruder—producing a foamed article, or can remain relatively unexpanded, and foamed-in-place. US 2015/0322226 also describes the use of microspheres for foaming polymers. WO2019050915 describes the use of microspheres for foaming PVDF polymers. In US20050031811, a melt composition for heat shrinkable foam structures is described comprising expandable microspheres.

### Expandable Microspheres

In one preferable embodiment, microspheres are used to create the foam of the present invention. The microspheres are small hollow particles with a polymer shell that can encapsulate various liquids or gases. The expandable microspheres of the invention are typically powders and can come in unexpanded or expanded forms. Upon heating, the polymer shell will soften and the liquid inside the sphere changes state to create a large volume of gas with high pressure—which will expand the microsphere substantially.

The spheres can have various diameters (typically with a wide size distribution), shell thickness, shell composition (typically lightly cross linked acrylates, methacrylates and their copolymers with acrylonitrile), and can contain various liquids or gases (typically, isooctane, isobutene, isopentane, or mixtures of thereof), such as Akzo Nobel Expancel® products and described for example in U.S. Pat. Nos. 3,615,972, 6,509,384 or 8,088,482. The microspheres can additionally contain finely dispersed organic or non-organic material both inside and on the surface. Microspheres are commercially available from several manufacturers in a wide range of particle size and distributions. Generally, the microspheres have an average particle diameter of 10 to 140 micron, and more preferably 20 to 120 micron, with a shell thickness of several micron before expansion and average diameter of tens of micron with shell thickness of less than one micron after expansion are typical.

There are several processing advantages to forming a fluoropolymer foam with expandable microspheres: 1) There is less gas/polymer matrix interaction and thus concerns about the reduction of melt strength due to dissolved gas is reduced. 2) The compatibility of the blowing gas and polymer represented by its solubility, diffusivity and permeability are of much less concern. This allows one to decouple the cell initiation and growth phenomenon from polymer/gas compatibility. 3) The temperature profile for the extruder can be more similar to the temperature profile used with the neat polymer extrusion and the processing window is wider compared to the use of a gaseous blowing agent or a chemical blowing agent. 4) The bubbles formed by the expanding gas typically do not burst and coalesce into large voids, as can happen with gaseous physical blowing agents from both gas injected and chemical blowing agents. 5) The cell size distribution in the foam is a function of the particle size distribution of the microsphere particles. Thus, particular care should be given to the combination of the temperature and residence time of the process, since keeping the mixture at high temperature for long time would cause the gas inside the formed bubbles to escape from their thin shell into the polymer matrix where the bubbles would collapse. The control of temperature and residence time of the process is critical to forming a good closed foam. 6) Added nucleating agent is not necessary with the microspheres. The microsphere foaming of the invention can be used in a continuous or batch foaming process. 7) Good quality foam can be produced with what would be considered “low” viscosity PVDF resins, that would normally result in cell collapse or poor foaming. A low viscosity PVDF resin would be one that has a melt viscosity of 10 kpoise or lower when measured by Capillary Rheometry at 230 C. and measured at 100 s−1. Preferably, the low viscosity PVDF would have a melt viscosity of higher than 1 kpoise, or higher than 2 kpoise.

When the foamable microspheres have an acrylate-containing shell, dispersion by a melt process into a PVDF matrix is easier and more completely and uniformly dispersed, since acrylic polymers are at least partially miscible with PVDF in the melt. Miscibility can be shown by DSC data, as well as a transparent mixture. Insoluble or immiscible materials generally result in a two-phase morphology, and is typically opaque.

The choice of the particular microspheres for use in the composition will be determined based on the polymer matrix, processing temperature, viscosity, and the required cell size and structure. Any suitable percentage of microspheres in expanded or unexpanded form or a combination of both can be used in the formulation. Generally, the level of microspheres in the final foamed product ranges from 0.1 to 7 weight percent, preferably from 0.12 to 4.9 weight percent, and more preferably from 0.2 to 4.2 weight percent. A blend of two or more types of microspheres is contemplated in the invention, including two or more different average particle size microspheres, two or more different microsphere blowing agent chemistries, two or more different activation temperature, or a combination of several of these different microspheres.

Further, the use of the microsphere combined with a physical or chemical blowing agent is also contemplated.

### Masterbatch

While the microspheres and fluoropolymer matrix polymer can be combined directly, in one preferred embodiment the microspheres are combined with a polymer carrier for ease of handling—such as in producing a pellet that can be easily used in an extrusion process. The polymer carrier should have a melting point below the activation temperature of the foamable microsphere. The polymer carrier resin can be any found useful including those polymers considered miscible such as PVDF copolymers and PMMA, and also including polymers considered immiscible such as polyethylene, polyethylene copolymers, ethylene vinyl alcohol (EVOH) and ethylene vinyl acetate (EVA). Of importance, the carrier resin cannot adversely affect the burning performance of the filler rod when used in a cable product and tested to NFPA-262.

The masterbatch composition may be in any form, with a powder, paste, or a pellet being preferred. In addition to the microspheres and carrier polymer, other additives may be blended into the masterbatch. Two or more masterbatches, each containing different components, or different levels of the same components can be used.

The level of foamable microspheres in the masterbatch ranges from 5 to 95 wt. %, preferably from 10 to 75 wt. %, more preferably from 25 to 75 wt. % and most preferable from 40 to 70 wt. %. The amount of this masterbatch used with the fluoropolymer matrix ranges from 0.1 to 10 wt. %, preferably from 0.2 to 8 wt. %, more preferably from 0.3 to 7 wt. %, and most preferably from 0.5 to 6 wt. %.

### Strength Member

The strength member can be in a multitude of forms including monofilaments, braids, multifilaments wires and produced from high strength polymers such as polyaramids (Kevlar®), steel, ceramic or glass. Solid strength members can also be used which is typically comprised of a composite rod containing glass contained in a thermoset polymer with epoxy polymers being common. The strength member can be in any shape or size. Altering the strength member used would allow the preferred principle of this invention to be extended without losing the advantages of the invention: varying the type or shape of strength member, removing the strength member or including multiple strength members. Dimensional changes include but are not limited to differences in width, length, thickness, overall shape (round, oval, star, regular polygons, etc. . . . The strength member does not need to be centrally located and can be located anywhere within the strength member and also could be wrapped or braided on the outside of the filler rod.

### Manufacturing the Rod

The filler rod is preferably manufactured by extruding the foamed PVDF around a strength member.

In a typical manufacturing process producing PVDF filler rod, the manufacturing line would consist of a single screw extruder outfitted with a crosshead extrusion die having a tube on set up. The PVDF polymer would be introduced into the extruder through a hopper. If using an internal blowing agent, the blowing agent could be pre-blended as a pellet blend before being fed into the hopper, or each could be fed separately into the hopper. Of importance is maintaining a consistent ratio at the target composition. Process conditions would be dictated by the polymer and foaming method selected. Process conditions such as extrusion speed, screw design, process temperatures, water bath temperature, the use of a water bath, tooling sizes, draw down ratio's, draw balance or tooling position can all be adjusted to achieve target dimensions, density reduction and final product properties. The strength member would be pulled through the crosshead with the line speed controlled by a capstan, belt puller, or similar equipment. The foamed PVDF polymer would be extruded around the strength member as it exits the crosshead. The strength member could consist of one or more multifilament fibers, monofilament, rod, or any combination thereof. The use of pressure, semi pressure extrusion or any other method known in the art could be used in lieu of the preferred method of tube on extrusion. The filler rod would normally be cooled by passing through a water tank and at the end of the line and then collected on a reel.

The filler rod can be produced by co-extrusion or tandem extrusion to produce a multilayered construction. Co-extrusion is performed using a co-extrusion die that can extrude two polymer resins simultaneously. Two or more extruders are used and attached to the co-extrusion die with each extruder feeding a separate polymer melt. A typical coextruded structure would be a core structure having an external jacket. A co-extruded filler rod would be comprised of a foamed core that may or may not have a centrally located strength member, and a non-foamed outer jacket. The polymer used for the foamed core and the non-foamed outer jacket could be the same PVDF polymer, or could be different PVDF polymers. In a preferred embodiment of this invention, the PVDF used for the non-foamed outer jacket has a lower viscosity than is used to produce the foam core. By selecting a lower viscosity PVDF resin, preferably at least 1 kpoise lower, more preferably at least 5 kpoise lower that the PVDF polymer used in the foam, on the outside, a thinner non-foamed outer jacket can be obtained. Minimizing the non-foamed outer jacket is desirable to minimize filler rod cost. The use of an outer jacket would be included for several reasons including to produce a smooth or shiny surface, to improve printability or for aesthetic reasons.

The application of an outer jacket can also be achieved by extrusion of the initial foam core followed by application of the outer jacket in two separate extrusion steps. The term tandem extrusion refers to when a two-layer jacket is applied using two separate extrusion heads located on the same extrusion line.

The Co-extrusion or multilayered systems including products co-extruded with other PVDF polymers, other Fluoropolymer polymers or non-fluorinated polymers using a multilayer crosshead or in tandem.

### Aspects of the Invention

Aspect 1: A filler rod for an optical fiber cable, said filler rod comprising a foamed polyvinylidene fluoride polymer composition, said composition comprising a polyvinylidene fluoride polymer.

Aspect 2: The filler rod of aspect 1 wherein the polyvinylidene fluoride polymer has a melt viscosity of 4 to 35 kpoise, preferably between 6 and 30 kpoise, measured at 230° C. at a shear rate of 100 s⁻¹.

Aspect 3: The filler rod of any one of the preceding aspects wherein the polyvinylidene fluoride polymer is a homopolymer, or a copolymer having at least 70 percent by weight polyvinylidene fluoride, preferably at least 80% polyvinylidene fluoride and most preferred is at least 85% polyvinylidene.

Aspect 4: The copolymer of aspect 3 wherein the comonomer comprises hexafluoropropylene (HFP).

Aspect 5: The copolymer of aspect 3 wherein the comonomer comprises at least one of hexafluoropropylene (HFP), tetrafluoroethylene (TFE), chlorotetrafluoroethylene (CTFE) and combination thereof.

Aspect 6: The filler rod of any one of the preceding aspects wherein the polyvinylidene fluoride polymer composition contains a flame retardant additive that increases the limiting oxygen index.

Aspect 7: The filler rod of aspect 6 where the flame retardant additive comprises at least one of calcium tungstate, calcium molybdate, talc, or an aluminum silicate.

Aspect 8: The filler rod of aspect 6 or 7 wherein the flame retardant additive comprises from at least 0.1 wt %, preferably at least 0.4 wt. %, more preferably between 0.9 and 2.1 wt. % of the polymer composition.

Aspect 9: The filler rod of any one of the preceding aspects wherein the polyvinylidene fluoride polymer comprises at least 5 weight % of a comonomer.

Aspect 10: The filler rod of any one of the preceding aspects wherein the density reduction of the polyvinylidene fluoride polymer due to foaming is from 5% to 70% reduction, preferably 15 to 60% reduction, most preferably 20 to 50% reduction.

Aspect 11: The filler rod of any one of the preceding aspects wherein the filler rod comprises expanded microspheres.

Aspect 12: The filler rod of any one of the preceding aspects wherein the outside surface of the foamed filler rod is not foamed.

Aspect 13: The filler rod of any one of the preceding aspects wherein the composition further comprising filler and additives.

Aspect 14: The filler rod of any one of the preceding aspects wherein the composition further comprising fire retardant additive.

Aspect 15: The filler rod of any one of the preceding aspects further comprising a strength member.

Aspect 16: The filler rod of any one of the preceding aspects wherein the strength member is centrally located in the rod.

Aspect 17: The filler rod of any one of the preceding aspects where the strength member is comprised of high strength poly aromatic fibers such as poly-para-phenylene terephthalamide fibers, glass fiber, UHMWPE fibers, or polymer impregnated (such as epoxy) glass rod.

Aspect 18: An optical fiber cable comprising:
a. at least one filler rod of any one of the preceding aspects,
b. at least one core tube;
c. at least one optical fiber in at least one core tube; and
d. a cable jacket covering the core tube and the filler rod.

Aspect 19: The optical cable of aspect 18 where the optical fiber cable containing the filler rod is plenum or riser rated.

Aspect 20: The optical cable of claim 18 or 19 wherein a cross-sectional area of the filler rod is within 5% of the cross-sectional area of at least one core tube in the optical fiber cable.

Aspect 21: A method of manufacturing a filler rod for an optical fiber cable comprising the steps of: extruding an rod from polyvinylidene fluoride polymer, wherein the polyvinylidene fluoride polymer is being foamed during the extrusion, preferably extruding the PVDF around a strength member.

Aspect 22: A method of manufacturing a filler rod with an unfoamed outer layer and a foamed polyvinylidene fluoride polymer core comprising the steps of coextruding in a single extrusion step (coextrusion) or as two separate extrusion steps (tandem extrusion).

Aspect 23: The method of aspect 21 or 22 wherein the filler rod is the filler rod of any of claims 1 to 17.

### EXAMPLES

### Example 1

A Filler Rod comprised of a foamed PVDF resin with a centrally located strength member was produced using a small lab extrusion line commonly used to produce cable products. The extruder consisted of a 1.5″ Davis Standard single screw extruder outfitted with a barrier screw and a B&H 30 crosshead. The B&H crosshead contained a 0.130″ diameter die and a recessed tip to produce a “semi-pressure” extrusion set up. The downstream equipment included a 4-foot cooling trough with room temperature water, a belt puller and take up spooler.

The temperature profile used was as follows:
i. Temperature Profile(° F.): 380-390-400-410-430-420-420-410

A 5 lb blend of consisting of 98% Kynar® 460 and 2% KYFLEX™ EZ-FOAM (produced by Arkema Inc.) was hand mixed in a large polyethylene bag and then placed into the feed hopper located on the extruder feed throat. The screw speed was set at 25 RPM and the blend was fed into the extruder until the blend started exiting the crosshead. The extrudate was examined to ensure foaming was occurring in the melt.

The screw was slowed to 12 RPM and allowed time to purge for 10 minutes to allow the process to stabilize. The melt pressure was measured at 1184 psi and a direct melt temperature measurement using a thermocouple in the melt was recorded at 386° F.

The extruder screw was stopped (set to 0 RPM), Excess material scraped from the die using a brass scraper, and a polyaramid strand (TWARON® ST-47, a brand name of Teijin Aramid) was fed through the crosshead.

The extruder screw was restarted at a screw speed set to 12 RPM, and the polyaramid strand pulled through using a belt puller. The foamed filler rod exiting the crosshead was pulled through water bath set at room temperature. Crosshead adjustments were made to center the strength member within the foamed filler rod.

The filler rod produced had a round cross section with an outside diameter of 3.75 mm and a 51% reduction in density. Density reduction was measured using a bench top Densimeter on foamed PVDF filler rod after removing the polyaramid strength member.

### Example 2

A foamed filler rod consisting of an unfoamed 0.015″ thick jacket of Kynar® 460 and the 51% foamed, 3.75 mm diameter filler rod from Example 1 was produced using a small lab extrusion line commonly used to produce cable products. The extruder consisted of a 1.5″ Davis Standard single screw extruder outfitted with a barrier screw and a B&H 30 crosshead. The B&H crosshead contained a die with an inside diameter of 0.525″ and a tip with an outside diameter of 0.425″ aligned flush with the die to produce a “Tube-on” extrusion set up. The downstream equipment included a 4-foot cooling trough with room temperature water, a belt puller and take up spooler.

The temperature profile used was as follows:
Temperature Profile(° F.): 380-390-400-410-430-420-420-410

5 pounds of Kynar® 460 was scooped into the hopper located on the extruder feed throat. The screw speed was set at 25 RPM and the Kynar® 460 was fed into the extruder until the resin started exiting the crosshead.

The screw was slowed to 15 RPM and allowed time to purge for 10 minutes to allow the process to stabilize. The melt pressure was measured at 980 psi and a direct melt temperature measurement using a thermocouple in the melt was recorded at 397° F.

The extruder screw was stopped (set to 0 RPM), excess material scraped from the die using a brass scraper, and a spool containing 3.75 mm foamed Kynar® filler rod with a polyaramid strength member (see Example 1) was fed through the crosshead. This filler rod was pulled through the water bath and into a belt puller set at a rate of 10 feet per minute.

The extruder screw was restarted at a screw speed set to 15 RPM, and the foamed filler rod (see Example 1) was pulled through using a belt puller at a rate of 10 feet per minute and collected on a take up spooler. The filler rod produced had a round cross section with an outside diameter of 4.5 mm making the process conditions for this tube on process as follows.
a. Draw Index: 1.029
b. Area Draw Down Ratio: 9.901
c. Outer (unfoamed) wall thickness: 0.015″

### Example 3

A Filler Rod comprised of a foamed PVDF/HFP co-polymer with a centrally located strength member was produced using a small lab extrusion line commonly used to produce cable products. The extruder consisted of a 1.5″ Davis Standard single screw extruder outfitted with a barrier screw and a B&H 30 crosshead. The B&H crosshead contained a 0.130″ diameter die and a recessed tip to produce a “semi-pressure” extrusion set up. The downstream equipment included a 4-foot cooling trough with room temperature water, a belt puller and take up spooler.

The temperature profile used was as follows:
a. Temperature Profile(° F.): 380-390-400-410-430-420-420-410

A 5lb blend of consisting of 98% Kynar Flex® 3030-10 and 2% KYFLEX™ EZ-FOAM was hand mixed in a large polyethylene bag. and then placed into the feed hopper located on the extruder feed throat. The screw speed was set at 25 RPM and the blend was fed into the extruder until the blend started exiting the crosshead. The extrudate was examined to ensure foaming was occurring in the melt.

The screw was slowed to 12 RPM and allowed time to purge for 10 minutes to allow the process to stabilize. The melt pressure was measured at 704 psi and a direct melt temperature measurement using a thermocouple in the melt was recorded at 365° F.

The extruder screw was stopped (set to 0 RPM). Excess material scraped from the die using a brass scraper, and a polyaramid strand (TWARON® ST-47) was fed through the crosshead.

The extruder screw was restarted at a screw speed set to 12 RPM, and the polyaramid strand pulled through using a belt puller. The foamed filler rod exiting the crosshead was pulled through water bath set at room temperature. Crosshead adjustments were made to center the strength member within the foamed filler rod.

The filler rod produced had a round cross section with an outside diameter of 3.94 mm and a 58% reduction in density. Density reduction was measured using a bench top Densimeter on foamed PVDF filler rod after removing the polyaramid strength member.

### Example 4

A special filler rod was prepared to study the effects of material selection and foaming on flame and smoke properties as tested per NFPA 262. The special filler rod was comprised of a LSPVC inner strength member and an outer jacket comprised of the test material. The strength member was comprised of a twisted copper core coated with 0.020 inches of a plenum rated LSPVC compound and was produced using a 1.5″ Davis Standard single screw extruder outfitted with a barrier screw and a B&H 30 crosshead as described in the previous examples. The B&H crosshead contained a suitable tube on set up with a low draw down ratio of 5 to 1 to achieve the target coating thickness. The downstream equipment consisted of a 4-foot cooling trough with room temperature water, a belt puller and take up spooler. The temperature profile used was as follows: Temperature Profile(° F.): 380-390-400-410-410-410-410-410.

The filler rod was produced by applying a test material over the LSPVC strength member to achieve a target outside diameter (OD) of 0.190 inches. Extrusion of the test materials was performed on the same extrusion line used to produce the strength member but with tooling conditions adjusted as needed. Filler rods produced with a foamed PVDF outer layer were produced using the preferred foaming technology. The foaming agent used was KYFLEX™ EZ-FOAM produced by Arkema Inc. The low smoke PVC used was Fireguard® LS FR PVC produced by Tekor Apex. The PVDF copolymer used was Kynar Flex® 3120-50 produced by Arkema Inc. The foaming agent when used was added at 3.5% to achieve a high density reduction. Density reduction was measured using a bench top Densimeter on foamed PVDF filler rod after removing the strength member and was determined to be 60%. Three filler rods were prepared and then tested per NFPA 262 with results provided in the following table.

| | | Flame | | |
|---|---|---|---|---|
| Filler | | Spread | Average | Peak |
| Rod | Jacket Material | (ft) | Smoke | Smoke |
| LSPVC | LSPVC, Solid | 2.2 | 0.068 | 0.47 |
| LSPVC | PVDF copolymer, Solid | 0 | 0.043 | 0.31 |
| LSPVC | PVDF copolymer, 60% foamed | 0 | 0.037 | 0.34 |

Test results indicate the filler rod produced with the PVDF copolymer jackets tested better than the filler rod produced with the LSPVC jacket with much lower flame spread and lower smoke generation. The addition of the foam to the PVDF copolymer layer further improved smoke generation with similar flame spread values (0 flame spread) being reported for the solid and foamed PVDF copolymer sample.

1. A filler rod for an optical fiber cable, said filler rod comprising a foamed polyvinylidene fluoride polymer composition, said composition comprising a polyvinylidene fluoride polymer, wherein the polyvinylidene fluoride polymer has a melt viscosity of 4 to 35 kpoise, measured at 230° C. at a shear rate of 100 s⁻¹.

2. (canceled)

3. The filler rod of claim 1 wherein the polyvinylidene fluoride polymer is a homopolymer, or a copolymer having a comonomer and at least 70 percent by weight vinylidene fluoride.

4. The copolymer of claim 3 wherein the comonomer comprises hexafluoropropylene (HFP).

5. The copolymer of claim 3 wherein the comonomer comprises at least one of hexafluoropropylene (HFP), tetrafluoroethylene (TFE), chlorotetrafluoroethylene (CTFE) and combination thereof.

6. The filler rod of claim 1 wherein the polyvinylidene fluoride polymer composition contains a flame retardant additive that increases the limiting oxygen index.

7. The filler rod of claim 6 wherein the flame retardant additive comprises at least one of calcium tungstate, calcium molybdate, talc, or an aluminum silicate.

8. The filler rod of claim 6 wherein the flame retardant additive comprises from at least 0.1 wt % of the polymer composition.

9. The filler rod of claim 3 wherein the comonomer comprises at least 5 weight % of the polyvinylidene fluoride polymer.

10. The filler rod of claim 1 wherein the density reduction of the polyvinylidene fluoride polymer due to foaming is from 5% to 70% reduction.

11. The filler rod of claim 3 wherein the filler rod comprises expanded microspheres.

12. The filler rod of claim 3 wherein the outside surface of the filler rod is not foamed.

13. The filler rod of claim 3 wherein the composition further comprises filler and additives.

14. The filler rod of claim 3 wherein the composition further comprises fire retardant additive.

15. The filler rod of claim 3 further comprising a strength member.

16. (canceled)

17. (canceled)

18. An optical fiber cable comprising:
a. at least one filler rod of claim 3,
b. at least one core tube;
c. at least one optical fiber in at least one core tube; and
d. a cable jacket covering the core tube and the filler rod.

19. The optical cable of claim 18 wherein the optical fiber cable containing the filler rod is plenum or riser rated.

20. The optical cable of claim 18 wherein the cross-sectional area of the filler rod is within 5% of the cross-sectional area of at least one core tube in the optical fiber cable.

21. A method of manufacturing a filler rod for an optical fiber cable comprising the steps of:
a) extruding a rod comprising a polyvinylidene fluoride polymer, wherein the polyvinylidene fluoride polymer is being foamed during the extrusion, optionally extruding the PVDF around a strength member.

22. A method of manufacturing a filler rod with an unfoamed outer layer and a foamed polyvinylidene fluoride polymer core comprising the steps of coextruding the outerlayer and the core in a single extrusion step (coextrusion) or extruding the outerlayer and the core in as two separate extrusion steps (tandem extrusion).

23. The method of claim 21 wherein the filler rod comprises a foamed polyvinylidene fluoride polymer composition, said composition comprising a polyvinylidene fluoride polymer, the polyvinylidene fluoride polymer has a melt viscosity of 4 to 35 kpoise, measured at 230° C. at a shear rate of 100 s⁻¹.
